(19) United States
(12) Patent Application Publication
(10) Pub. No.: US 2013/0209308 A1
(43) Pub. Date: Aug. 15, 2013

(54) METHOD OF MAKING A METALLIC POWDER AND POWDER COMPACT AND POWDER AND POWDER COMPACT MADE THEREBY

(71) Applicants: Oleg A. Mazyar, Houston, TX (US); Michael H. Johnson, Katy, TX (US); David Ernest Rodrigues, Missouri City, TX (US)

(72) Inventors: Oleg A. Mazyar, Houston, TX (US); Michael H. Johnson, Katy, TX (US); David Ernest Rodrigues, Missouri City, TX (US)

(73) Assignee: Baker Hughes Incorporated, Houston, TX (US)

(21) Appl. No.: 13/397,492

(22) Filed: Feb. 15, 2012

(51) Int. Cl. B22F 1/02; B32B 15/02; C22C 21/00; B22F 3/12; B22F 9/18; C22C 23/00

(52) U.S. Cl. 419/33; 75/343; 75/354; 420/402; 420/528; 419/35; 419/23; 428/548

(57) ABSTRACT

A method of making a nanoscale metallic powder is disclosed. The method includes providing a base material comprising a metallic compound, wherein the base material is configured for chemical reduction by a reductant to form a metallic material. The method also includes forming a powder of the base material, the powder comprising a plurality of powder particles, the powder particles having an average particle size that is less than about 1 micron. The method further includes disposing the powder particles into a reactor together with the reductant under an environmental condition that promotes the chemical reduction of the base material and formation of a plurality of particles of the metallic material.

### BACKGROUND

Well drilling, completion and production operations, such as those employed for oil and natural gas wells and carbon sequestration, often utilize wellbore components or tools that, due to their function, are only required to have limited service lives that are considerably less than the service life of the well. After a component or tool service function is complete, it must be removed or disposed of in order to recover the original size of the fluid pathway for use, including hydrocarbon production, CO₂ sequestration, etc. Disposal of components or tools has conventionally been done by milling or drilling the component or tool out of the wellbore, which are generally time consuming and expensive operations, particularly in horizontal sections of the wellbore.

In order to eliminate the need for milling or drilling operations, the removal of components or tools by dissolution or corrosion using controlled electrolytic materials, such as those having a cellular nanomatrix that can be selectively and controllably degraded or corroded in response to a wellbore environmental condition, such as exposure to a predetermined wellbore fluid, as been described in, for example, U.S. patent application Ser. No. 12/633,688 filed Dec. 8, 2009, entitled METHOD OF MAKING A NANOMATRIX POWDER METAL COMPACT.

The use of controlled electrolytic materials formed as powder compacts from metal powders to manufacture various downhole tools and components makes it very desirable to develop improved metal powders used to form the compacts and improved, cost effective methods of making the metal powders in high volumes, as well as improved methods of using them to form powder metal compacts.

### SUMMARY

In an exemplary embodiment, a method of making a nanoscale metallic powder is disclosed. The method includes providing a base material comprising a metallic compound, wherein the base material is configured for chemical reduction by a reductant to form a metallic material. The method also includes forming a powder of the base material, the powder comprising a plurality of powder particles, the powder particles having an average particle size that is less than about 1 micron. The method further includes disposing the powder particles into a reactor together with the reductant under an environmental condition that promotes the chemical reduction of the base material and formation of a plurality of particles of the metallic material.

In another exemplary embodiment, a metallic powder is disclosed. The metallic powder comprises a plurality of powder particles comprising magnesium or aluminum, or a combination thereof, wherein the powder particles have a predetermined particle morphology resulting from reduction from a magnesium compound or an aluminum compound, or a combination thereof, respectively.

In yet another exemplary embodiment, a method of making a powder metal compact is disclosed. The method includes providing a metallic powder that comprises a plurality of powder particles comprising magnesium or aluminum, or a combination thereof, by direct reduction of a base powder comprising a plurality of powder particles of a magnesium compound or an aluminum compound, or a combination thereof, respectively, the base powder particles having an average particle size that is less than about 1 micron. The method also includes depositing a nanoscale metallic coating layer of a metallic coating material on outer surfaces of the metallic powder particles to form coated metallic powder particles. The method further includes forming a powder metal compact by sintering of the nanoscale metallic coating layers of the plurality of coated metallic powder particles to form a substantially-continuous, cellular nanomatrix of the metallic coating material and a plurality of dispersed particles comprising the metallic powder particles dispersed within the cellular nanomatrix.

### BRIEF DESCRIPTION OF THE DRAWINGS

Referring now to the drawings wherein like elements are numbered alike in the several Figures:

FIG. 1 is a flowchart of an exemplary embodiment of a method of making a metallic powder as disclosed herein;

FIG. 2 is a flowchart of an exemplary embodiment of a method of making a powder compact from a metallic powder as disclosed herein;

FIG. 3 is a schematic cross-sectional view illustrating an exemplary embodiment of a method of making metallic powders as disclosed herein, as well as the compound powder particles used and metallic particles formed according to the method;

FIG. 4 is a schematic cross-sectional view illustrating a second exemplary embodiment of a method of making a metallic powders as disclosed herein;

FIG. 5 is a schematic cross-sectional view illustrating a third exemplary embodiment of a method of making a metallic powder as disclosed herein;

FIG. 6 is a schematic cross-sectional view of coated metallic powder particles as disclosed herein; and

FIG. 7 is a schematic cross-sectional view of a powder compact as disclosed herein.

### DETAILED DESCRIPTION

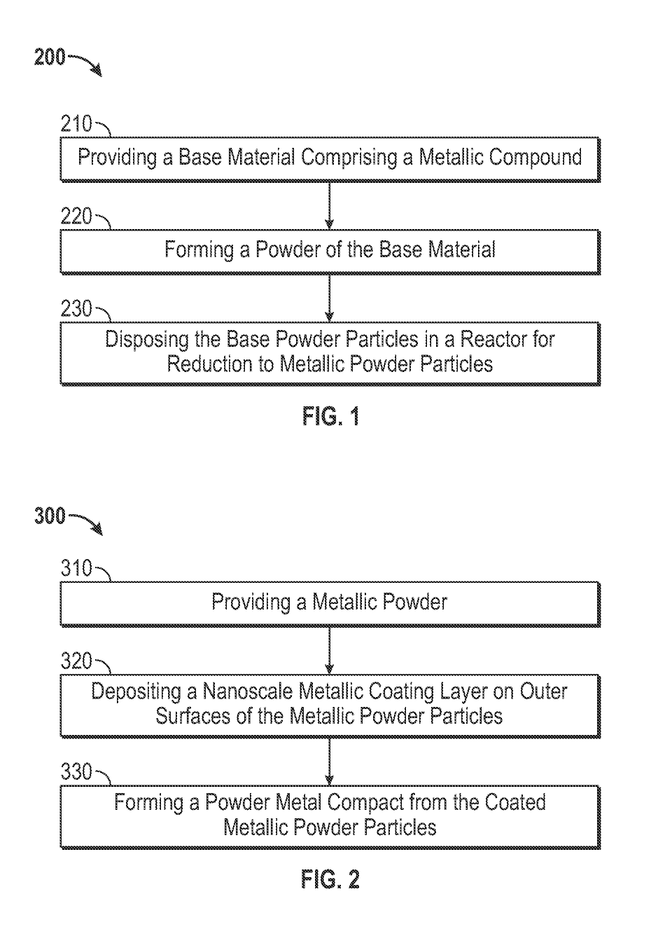

Referring to the Figures, more particularly FIGS. 1-7, a method 200 for making metallic powders 10, such as magnesium and aluminum metallic powders 10, suitable for use to form controlled electrolytic material (CEM) powder compacts 100 and a method of making 300 the electrolytic material (CEM) powder compacts 100 are disclosed. The metallic powders 10, such as magnesium and aluminum metallic powders 10, are formed directly from metallic compound powders 30, such as magnesium compound and aluminum compound powders 30, by the chemical reduction of these powders. These metallic powders 10 are structured in that they have powder particle morphologies or structures that are defined by the precursor compound powders 30, such as magnesium compound and aluminum compound powders, and the reducing agent or reductant selected and the method 200 used to make them. These structured metallic powders may have what may be termed as molecular powder particle morphologies or structures that include very fine particle sizes down to about 1 nm, particle clusters of these fine particles, porous particles and other shapes and features that are defined by the chemical reduction of the metallic portion of the compound powders 30 and the removal of the non-metallic portion of the compound powders 30 as reactant species. Powder compacts 100 formed from these metallic powders 10 may have a fine grain structure and display high ultimate compressive strength, because the movement of dislocations in such materials is hindered by the grain boundaries, which may be defined in part by the fine particle size of the metallic powders 10 used to form the compacts. High ultimate compressive strength may also be aided by the formation of intermetallic phases that may result during the formation of the compacts, as well as nanostructuring imparted to the metallic powder particles after they are formed as described herein.

Referring FIGS. 1 and 3-7, a method 200 of making nanoscale metallic powder 10, including nanoscale magnesium or aluminum metallic powder 10, is disclosed. The method 200 includes providing 210 a base material comprising a metallic compound, such as a magnesium compound or an aluminum compound, or a combination thereof, wherein the base material is configured for chemical reduction by a reductant 20 to form a metallic material 12 comprising powder particles 14. The method also includes forming 220 a powder 30 of the base material 32, the powder 30 comprising a plurality of powder particles 34, the powder particles 34 having an average particle size that is less than about 1 micron. The method 200 also includes disposing 230 the powder particles 34 in a reactor 22 together with the reductant 20 under an environmental condition 24 that promotes the chemical reduction of the base material and formation of a plurality of metallic powder particles 14 of the metallic material 12.

Providing 210 the base material comprising the metallic compound, such as a magnesium compound or an aluminum compound, or a combination thereof, wherein the base material is configured for chemical reduction by a reductant 20 to form a metallic material 12 may be accomplished by selecting a suitable metallic compound, such as a compound of magnesium or aluminum, or a combination of magnesium and aluminum compounds. Any suitable metallic compound, including various magnesium or aluminum compounds, may be selected that is capable of being reduced by suitable reductant 20 to form a metallic material such as, for example, magnesium or aluminum.

The base material 32 and metallic compound selected may include any suitable metallic compound. This includes compounds of various alkali metals, alkaline earth metals, transition metals, post transition metals and metalloids. Of these, compounds of magnesium and aluminum are particularly desirable for use to form metallic powders that can be used to provide CEM materials, as described herein.

As one example, the base material 32 and the metallic compound may include a magnesium compound and the plurality of metallic powder particles 14 of the metallic material 12 formed upon reduction of the base material 32 to form metallic powder 10 may include magnesium, or more particularly a magnesium alloy, or a combination thereof. The metallic material 12 may also include magnesium oxides, carbides or nitrides, or combinations thereof, as well as various intermetallic compounds comprising magnesium that may also be formed during the chemical reduction of the magnesium compound. Suitable magnesium compounds include magnesium chloride, magnesium fluoride, magnesium iodide, magnesium bromide, magnesium nitride, magnesium nitrate, magnesium bicarbonate, magnesium oxide, magnesium peroxide, magnesium selenide, magnesium telluride or magnesium sulfide, or a combination thereof. Suitable magnesium compounds may also include those which include other metallic elements in addition to magnesium.

As another example, the base material 32 selected may include an aluminum compound and the plurality of metallic powder particles 14 of the metallic material 12 formed upon reduction of the base material 32 to form metallic powder 10 may include aluminum, or more particularly an aluminum alloy, or a combination thereof. The metallic material 12 may also include aluminum oxides, carbides or nitrides, or combinations thereof, as well as various intermetallic compounds comprising aluminum that may also be formed during the chemical reduction of the aluminum compound. Suitable aluminum compounds include aluminum borate, aluminum bromide, aluminum chloride, aluminum iodide, aluminum fluoride, aluminum hydroxide, aluminum nitride, aluminum nitrate, aluminum oxide, aluminum phosphate, aluminum selenide, aluminum sulfate, aluminum sulfide, aluminum telluride or a combination thereof. Suitable aluminum compounds may also include those which include other metallic elements in addition to aluminum.

As yet another example, the base material 32 selected may include an aluminum compound and a magnesium compound in the plurality of metallic powder 10 particles of the metallic material 12 formed upon reduction of the base material 32 may include aluminum and magnesium as discrete particles, or as particles that include an alloy, intermetallic compound, or other combination of aluminum and magnesium. The selection of a base material 32 that includes a magnesium compound and an aluminum compound may also, upon reduction, provide a plurality of particles of the metallic material 12 that include magnesium or a magnesium alloy and aluminum or an aluminum alloy, or a combination thereof. Reduction of both aluminum and magnesium together will require selection of a suitable reductant 20 and environmental conditions 24 that enable reduction of both the aluminum compound and a magnesium compound, which in one embodiment may include reduction of both the aluminum compound and the magnesium compound at the same time.

Forming 220 a powder 30 of the base material 32 may be accomplished by any suitable method for forming a powder of the base material 32 using any suitable powder forming apparatus. Base materials 32 of the types described herein may be provided in various forms, including in the form of particulates of various average sizes that are larger than the sizes desired for use in accordance with method 200. Therefore, forming 220 may be used to reduce the average particle size to a size suitable for use in accordance with the method. In one embodiment, the powder 30 may be formed by ball milling the base material 32 to reduce the average particle size, and more particularly may be formed by cryomilling. The powder 30 of the base material 32 will have a particle size, such as an average particle size, which is selected to produce nanoscale metallic powder 10 particles upon reduction, which are defined herein as particles having a size less than about 1 micron, including an average particle size less than about 1 micron. In one embodiment, the powder 30 of the base material 32 may include powder particles 34 having a particle size sufficient to produce nanoscale metallic powder particles 14 upon chemical reduction, as described herein, and in another embodiment may have an average particle size that is less than about 1 micron, and in yet another embodiment may have an average particle size that is less than about 0.5 microns.

The method 200 also includes disposing 230 the powder particles 34 of the base powder 30 in a reactor 22 together with the reductant 20 under an environmental condition 24 that promotes the chemical reduction of the base material 32 and formation of a plurality of metallic powder particles 14 of the metallic material 12. The powder particles 34 may be reduced using any suitable combination of reductant, reactor 22 and environmental condition or conditions 24. Several exemplary embodiments are described below.

Any suitable reductant 20 may be utilized that is capable of reducing the metallic compound, such as an aluminum compound or a magnesium compound, or a combination thereof, selected to produce the desired metallic material 12. In one embodiment, the reductant 20 may include elements listed in Group I of the periodic table of the elements. Of the Group I elements, hydrogen and potassium are particularly desirable due to their high reactivity and relative abundance. The use of hydrogen as a reductant may include hydrogen or a hydrogen compound, and more particularly may include hydrogen gas. Suitable hydrogen compounds may include various hydrocarbons, hydrides such as lithium triethylborohydride, lithium borohydride, sodium borohydride, lithium aluminium hydride, diisobutylaluminium hydride, as well as various hydrogen-nitrogen compounds, such as ammonia, various ammonium compounds, hydrazine and others, that are configured to provide hydrogen anion (hydride ion) or hydrogen in amounts and chemical forms suitable for use as reductant 20. It will be understood that the selection and use of various hydrogen, potassium or other Group I compounds may require various intermediate reactions to liberate hydrogen anion (hydride ion), hydrogen or another Group I element so that it is available for use in the reduction of the base material 32.

Any suitable environmental condition or combination of conditions 24 may be employed to promote the reduction reaction necessary to reduce base material 32 and provide metallic material 12. In one embodiment, heat will be provided to raise the temperature to promote the reduction reaction. In another embodiment, the atmosphere within the reactor 22 will be controlled to limit the reactant species available within the reactor, such as by operating the reactor at a predetermined pressure, including a pressure that is lower than ambient atmospheric pressure, to lower the partial pressures of various reactants such as, for example, oxygen or nitrogen, or both of them. For example, it is important to effectively remove the products of the reduction reactions other than the desired product powder (such as H₂O, HCl, HBr, etc.) from the reactor to prevent the reverse reactions from occurring. The atmosphere of the reactor may also be controlled to exclude various reactant species, such as nitrogen or oxygen, or both of them, by the use of an inert carrier gas such as helium, argon or the like, wherein the reductant 20, such as hydrogen may be introduced together with the inert gas, such as by a gas flow through a sealed reactor that removes any undesirable reactant species and provides only a supply of predetermined reactant species, such as the reductant 20, for reaction with the base material 32. In other embodiments, the predetermined environmental conditions may include a predetermined temperature, predetermined pressure, predetermined reactant species, predetermined electric field, predetermined electric current or predetermined voltage, or a combination thereof.

The plurality of particles of the metallic material 12 formed by the chemical reduction of the compound powder particles 30 of the base material 32 may have any suitable particle size. In one embodiment the compound particles 30 of the base material 32, reductant 20 and environmental conditions 24 may be selected to provide an average particle size of the metallic powder 10 particles that is less than the particle size of the compound powder particles 30 of the base material 32. In another embodiment, the compound particles 30 of the base material 32, reductant 20 and environmental conditions 24 may be selected to provide an average particle size of the metallic powder 10 particles that is greater than the particle size of the compound powder particles 34 of the base material 32, such as where the metallic powder particles 14 produced by the reduction reaction agglomerate or otherwise combine with one another to produce metallic powder particles 14 that have a particle size greater than the compound powder particles 34 of the base material 32 from which they were reduced. In one example, metallic powder particles 14 reduced from different compound powder particles 34 may be fused to one another by metallic bonds, such as where the reduction reaction produces molten metallic powder particles 14 and one or more particles impact one another in the molten state and become metallurgical bonded or fused to one another. In another example, metallic powder particles 14 reduced from different compound powder particles 34 may cluster together due to interparticle attractive forces of various types, including van der Waals forces, electrostatic forces, and metallic and chemical bonds associated with surface adducts that may result from the reduction or other reactions within the reactor 22, or after the reduction reaction has been completed. While the method 200, and more particularly the compound powder particles 34, reductant 20 and environmental conditions 24 and reduction reaction, may be designed to produce metallic powder particles 14 having various particle sizes, it is particularly desirable that the method 200 be used to produce nanoscale metallic powder particles 14 for use in the manufacture of powder compacts 100 as described herein. In one embodiment, the plurality of metallic powder particles 14 of the metallic material 12 may have an average particle size of about 1 nm to about 1 micron. In another embodiment, the plurality of metallic powder particles 14 of the metallic material 12 may have an average particle size of about 5 nm to about 500 nm. In yet another embodiment, method 200 may be utilized to make very fine metallic powder particles 14 having an average particle size of about 1 nm to about 100 nm, and more particularly about 1 nm to about 50 nm, and even more particularly about 1 nm to about 15 nm.

Due to their formation by reduction of compound powder particles 34, the metallic powder particles 14 of the metallic material 12 have a particle morphology that is determined by the particle morphology or structure of the compound powder particles 34 (e.g., particle size and shape), and since these particles may be selected to have very small particle sizes as described herein, this may also include the molecular structure of the base material 32. In one embodiment, the metallic powder particles 14 may have a substantially spherical particle morphology, particularly where the reduction reaction may involve melting of the particles wherein surface tension effects may influence the particle morphology. In other embodiments, various types of particle agglomeration may result, as described herein, and produce fused particles or particle clusters. In yet another embodiment, the reduction reaction together with the molecular structure of the base material 32 may provide various porous particle morphologies upon reduction and removal of the non-metallic portion of the compound powder particles 34 of the base material 32 resulting in metallic powder particles 14 that include a porous network of the metallic material 12, wherein these particles may have an overall shape that reflects the shape of the compound powder particles 34, but are comprised of a porous network of the metallic material 12. As an example, the compound powder particles 34 may have a substantially spherical, flat planar, platelet or irregular structure defined by their crystal or molecular structure and the methods used to produce them, such as ball milling or cryomilling.

Disposing 230 the powder particles 34 of the base powder 30 in a reactor 22 together with the reductant 20 under an environmental condition 24 that promotes the chemical reduction of the base material 32 and formation of a plurality of metallic powder particles 14 of the metallic material 12 may be performed in any suitable reactor 22 using any combination of base material 32, reductant 20 and environmental conditions 24.

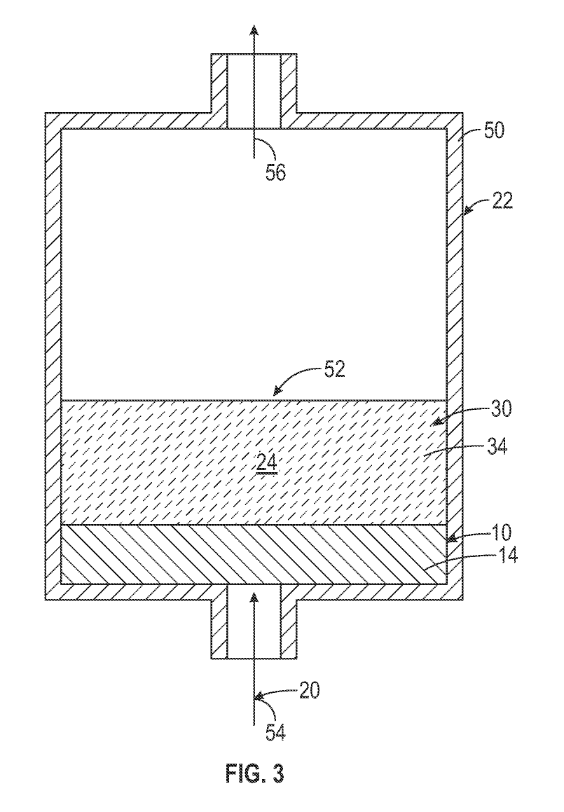

In one embodiment, the method 200 comprises disposing 230 the compound powder particles 34 in a fluidized bed reactor 50, wherein the powder particles comprise a fluidized bed 52 of powder particles and the reductant 20 comprises a fluid 54 that is configured to flow through and form the fluidized bed 52 of powder particles, as illustrated schematically in FIG. 3. In an exemplary embodiment, the fluid may include hydrogen gas or a hydrogen compound as described herein. The environmental condition 24 may include heating the fluidized bed 52, the fluid 54, or both, to a predetermined temperature sufficient to chemically reduce the powder particles and form the metallic material particles 14. The reaction may be performed as a batch reaction where the bed of compound powder particles 34 is established and the reduction reaction proceeds until the entire bed, or a portion thereof, is converted to metallic powder particles 14. Alternately, the reaction may be performed as a continuous reaction where the bed of compound powder particles 34 is continuously, or at predetermined intervals, replenished as the reduction reaction proceeds and the metallic powder particles 14 are separated in the bed, such as by density differences, are continuously, or at predetermined intervals, removed from the reactor 22. The chemical compounds and species 56 resulting from the reduction reaction may be exhausted from the reactor in any suitable manner.

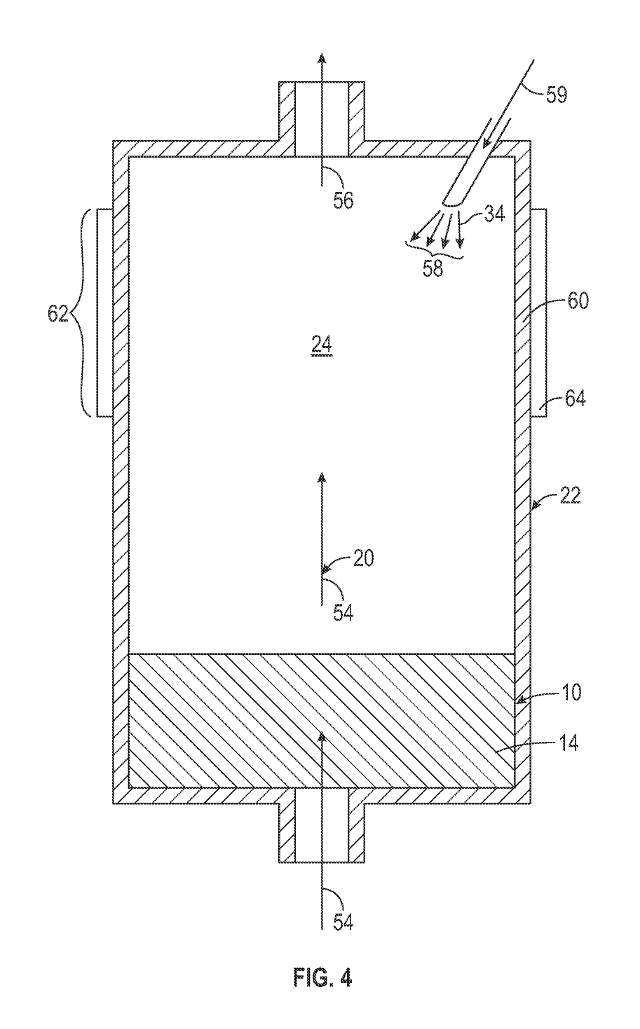

In another embodiment, disposing 230 the compound powder particles 34 into a reactor 22, such as a column reactor 60, includes spraying the compound powder particles 34 into the reactor to provide a stream of powder particles 58 and providing a flow, such as a countercurrent flow, of the reductant 20 as a fluid 54 through the reactor 22, as illustrated schematically in FIG. 4. In one embodiment, this may include a stream of molten powder particles 58. The flow of the reductant 20 through the reactor impinges upon the stream 58 of compound powder particles 34 facilitating the reduction of the particles. The environmental condition 24 may include, heating the stream 58 of powder particles and the reductant 20 to a predetermined temperature sufficient to chemically reduce the compound powder particles 34 and form the metallic powder particles 14 of the metallic material 12. In one embodiment, this may be accomplished by heating a portion 62 of the column reactor 60 with a heater 64. In this embodiment, the reductant 20 may include hydrogen or a hydrogen compound, and more particularly may include hydrogen gas, as well as an inert carrier gas. In this embodiment, the method 200 may also include, prior to spraying, combining the compound powder particles 34 with a liquid carrier to form a slurry 59 in order to disperse the particles in the liquid, wherein spraying the compound powder particles comprises spraying the slurry 59. Some powder 34 may dissolve in the carrier fluid (like Mg salt in water). This jet will evaporate in the reactor and may produce fine particles of Mg salt. The liquid carrier may include any suitable liquid carrier, and may include an organic or an inorganic liquid, or a combination thereof. An example of an inorganic liquid includes various aqueous liquids. As another example, the carrier may include a hydrocarbon liquid and may be selected to provide a source for hydrogen as a reductant 20.

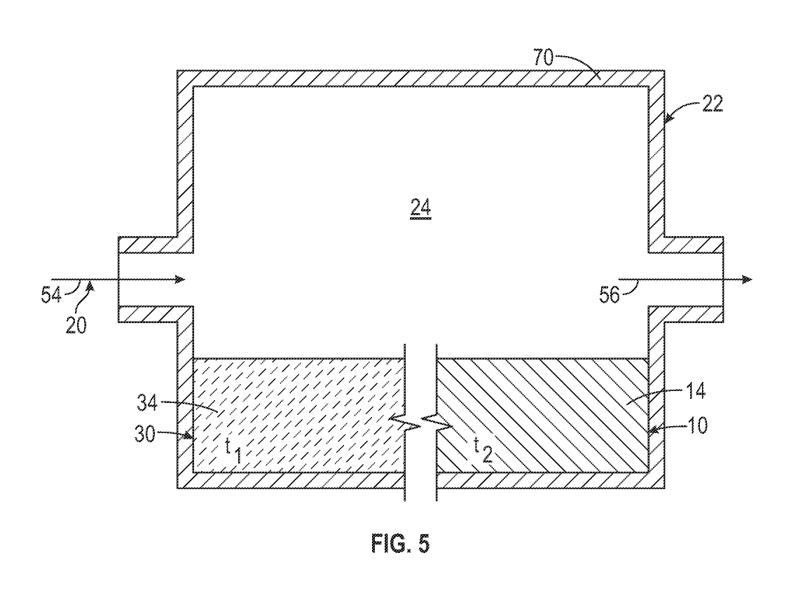

In a further embodiment, disposing 230 the compound powder particles 34 into a reactor 22 may include placing the compound powder particles 34 into a furnace 70, such as one of a batch furnace (FIG. 5), continuous furnace (not shown) or rotatable kiln (not shown). Disposing 230 may also include providing a flow of the reductant 20 as a fluid 54 through the furnace 70 as reactor 22, wherein the flow of the reductant 20 through the reactor exposing the compound powder particles 34 to the reductant 20. In this embodiment, the environmental condition 24 may also include heating the compound powder particles 34 and the reductant 20 in the furnace to a predetermined temperature sufficient to chemically reduce the compound powder particles 34 and form the metallic powder particles 14. In this embodiment, the reductant 20 may also include hydrogen or a hydrogen compound. The compound particles 34 are, for example, inserted as a batch at a time (t₁) and upon exposure to the reductant for a time sufficient to complete the reduction of the batch, the metallic powder particles 14 may be removed at a time (t₂).

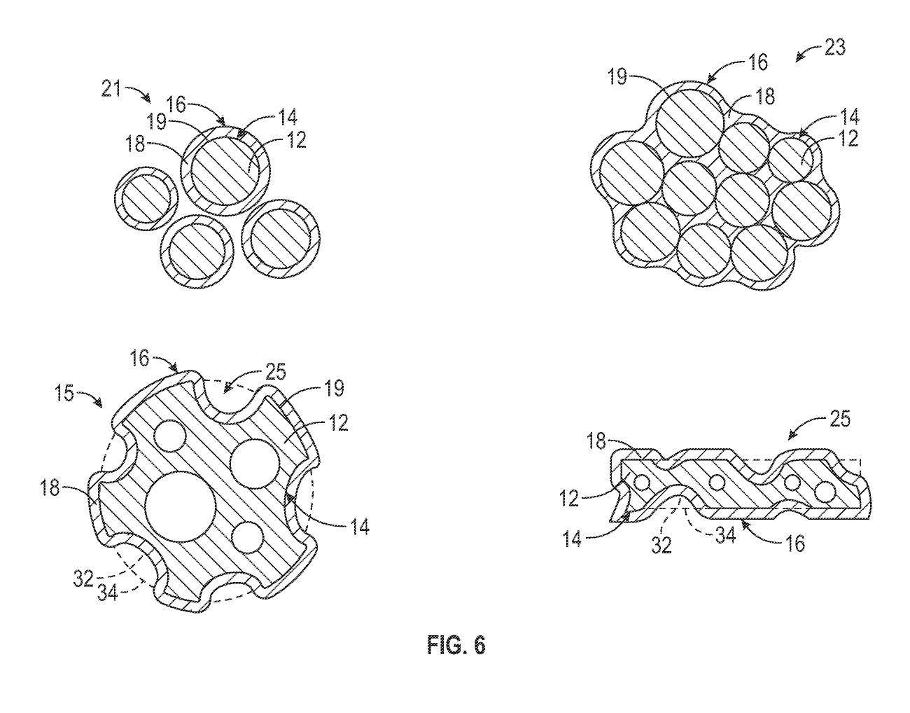

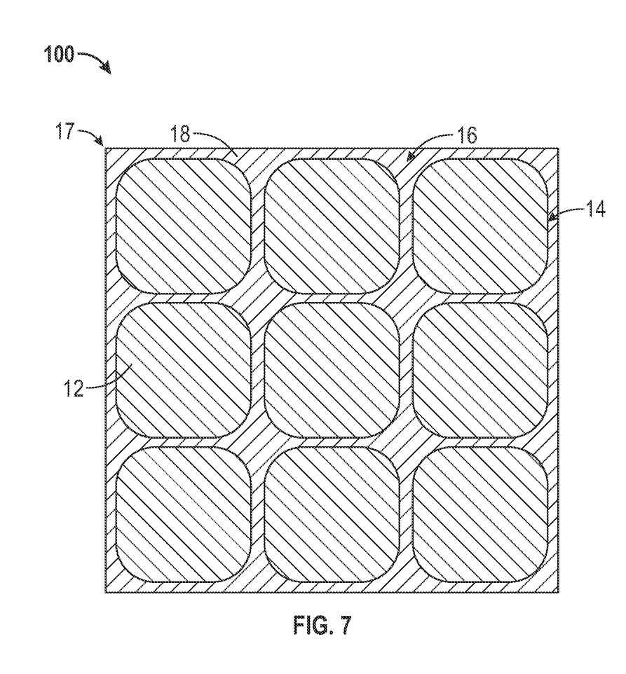

Once the metallic powder particles 14 have been formed, they may be used in a method 300 of making a powder metal compact 100, as described further below and illustrated in FIG. 7. The method 300 includes providing 310 a metallic powder 10 that comprises a plurality of metallic powder particles 14 that include magnesium particles or aluminum particles, or a combination thereof, as described herein, by direct reduction of a base powder 30 comprising a plurality of compound powder particles 34 of a metallic compound or metallic compounds, such as a magnesium compound or an aluminum compound, or a combination thereof, respectively, wherein the base powder particles 34 have an average particle size that is less than about 1 micron, and more particularly, from about 1 nm to less than about 1000 nm. In another embodiment, this may also include metallic compounds of Fe, Co, Cu, Ni, etc. as cathodic centers. The size of these inclusions can be from nm to micrometer in size. The method 300 also includes depositing 320 a nanoscale metallic coating layer 16 of a metallic coating material 18 on outer surfaces 19 of the metallic powder particles 14 to form coated metallic powder particles 15 as shown in FIG. 6. The method 300 further includes forming 330 a powder metal compact 100 by compaction of the nanoscale metallic coating layers 16 of the plurality of coated metallic powder particles 15 to form a substantially-continuous, cellular nanomatrix of the metallic coating material 17 and a plurality of dispersed particles comprising the metallic powder particles 14 dispersed within the cellular nanomatrix as illustrated in FIG. 7.

Providing 310 a metallic powder 10 that comprises a plurality of metallic powder particles 14 that include magnesium particles or aluminum particles, or a combination thereof, as described herein, by direct reduction of a base powder 30 comprising a plurality of compound powder particles 34 of a magnesium compound or an aluminum compound, or a combination thereof, respectively, wherein the base powder particles 34 have an average particle size that is less than about 1 micron has already been described herein in conjunction with method 200.

Depositing 320 a nanoscale metallic coating layer 16 of a metallic coating material 18 on outer surfaces 19 of the metallic powder particles 14 to form coated metallic powder particles 15 as shown in FIG. 6 may be performed by any suitable deposition method and apparatus, including various physical vapor deposition (PVD) methods, such as sputtering, electron beam evaporation, thermal evaporation, pulsed laser deposition and cathodic arc deposition, and chemical vapor deposition (CVD) methods, such as atmospheric pressure CVD, low-pressure CVD, ultra high vacuum CVD, direct liquid injection CVD, plasma-enhanced CVD, microwave-plasma-assisted CVD and metalorganic CVD. The nanoscale metallic coating layers 16 may include those described in co-pending U.S. patent application Ser. No. 12/633,682, filed on Dec. 8, 2009, which is incorporated herein by reference in its entirety. More particularly, in the case of magnesium and magnesium alloy metallic powder particles 14, the metallic powder particles 14 may, for example, comprise pure magnesium and various magnesium alloys, including Mg—Zr, Mg—Zn—Zr, Mg—Al—Zn—Mn, Mg—Zn—Cu—Mn or Mg—W alloys, or a combination thereof, and the various nanoscale metallic coating layers 16 may include Ni, Fe, Cu, Co, W, Al, Zn, Mn, Mg or Si, or an oxide, nitride, carbide, intermetallic compound or cermet comprising at least one of the foregoing, or a combination thereof, as described in co-pending U.S. patent application Ser. No. 13/220,824 filed on Aug. 30, 2011, which is incorporated herein by reference in its entirety. In the case of aluminum and aluminum alloy metallic powder particles 14, the metallic powder particles 14 may, for example, comprise pure aluminum and various aluminum alloys, including Al—Cu—Mg, Al—Mn, Al—Si, Al—Mg, Al—Mg—Si, Al—Zn, Al—Zn—Cu, Al—Zn—Mg, Al—Zn—Cr, Al—Zn—Zr, or Al—Sn—Li alloys, or a combination thereof, and the various nanoscale metallic coating layers 16 may include Ni, Fe, Cu, Co, W, Al, Zn, Mn, Mg or Si, or an oxide, nitride, carbide, intermetallic compound or cermet comprising at least one of the foregoing, or a combination thereof, as described in co-pending U.S. patent application Ser. No. 13/220,822 filed on Aug. 30, 2011, which is incorporated herein by reference in its entirety. The coating layer 16 may be applied to all of the morphological types of metallic powder particles 14 that may be produced by method 200, including to discrete fine particles 21, particle clusters 23 and to porous particles 25 of various particle shapes (FIG. 6).

Forming 330 a powder metal compact 100 by compaction of the nanoscale metallic coating layers 16 of the plurality of coated metallic powder particles 15 to form a substantially-continuous, cellular nanomatrix of the metallic coating material 18 and a plurality of dispersed particles comprising the metallic powder particles 14 dispersed within the cellular nanomatrix may be performed by any forming method and apparatus, including cold pressing, including cold isostatic pressing (CIP), hot pressing, including hot isostatic pressing (HIP), forging or extrusion, or a combination thereof. Forming 330 may also include heating of the powder and/or compact, either while the powder is being formed or afterward, or both.

Powder compact 100 includes a cellular nanomatrix of a nanomatrix material comprising the material of the coating layers 16 that are joined to one another during forming 330 having a plurality of dispersed metallic powder particles 14 dispersed throughout the cellular nanomatrix. The dispersed metallic powder particles 14 may be equiaxed in a substantially continuous cellular nanomatrix, or may be substantially elongated or otherwise distorted by forming 330. In the case where the dispersed metallic powder particles 14 are substantially elongated, the dispersed metallic powder particles 14 and the cellular nanomatrix may be continuous or discontinuous. The substantially-continuous cellular nanomatrix and nanomatrix material formed of sintered metallic coating layers 16 is formed by the compaction and sintering of the plurality of metallic coating layers 16 of the plurality of metallic powder particles 14, such as by CIP, HIP, extrusion or dynamic forging, or a combination thereof. The chemical composition of nanomatrix material may be different than that of coating material due to diffusion effects associated with the sintering. Powder metal compact 100 also includes a plurality of dispersed powder particles 14 that comprise metallic material 12. Dispersed metallic powder particles 14 correspond to and are formed from the plurality of metallic powder particles 14 and metallic material 12 of the plurality of metallic powder particles 14 as the metallic coating layers 16 are sintered together to form the nanomatrix. The chemical composition of the dispersed metallic material 12 may also change from the composition prior to forming due to diffusion effects associated with sintering.

As used herein, the use of the term cellular nanomatrix does not connote the major constituent of the powder compact 100, but rather refers to the minority constituent or constituents, whether by weight or by volume. This is distinguished from many matrix composite materials where the matrix comprises the majority constituent by weight or volume. The use of the term substantially-continuous, cellular nanomatrix is intended to describe the extensive, regular, continuous and interconnected nature of the distribution of the nanomatrix material within the powder compact 100. As used herein, “substantially-continuous” describes the extension of the nanomatrix material throughout the powder compact 100 such that it extends between and envelopes substantially all of the dispersed metallic powder particles 14. Substantially-continuous is used to indicate that complete continuity and regular order of the nanomatrix around each dispersed metallic powder particle 14 is not required. For example, defects in the coating layer 16 over metallic powder particles 14 may cause bridging of the metallic powder particles 14 during sintering of the powder compact 100, thereby causing localized discontinuities to result within the cellular nanomatrix, even though in the other portions of the powder compact the nanomatrix is substantially continuous and exhibits the structure described herein. In contrast, in the case of substantially elongated dispersed metallic powder particles 14, such as those formed by extrusion, “substantially discontinuous” is used to indicate that incomplete continuity and disruption (e.g., cracking or separation) of the nanomatrix around each dispersed metallic powder particle 14, such as may occur in a predetermined extrusion direction, or a direction transverse to this direction. As used herein, “cellular” is used to indicate that the nanomatrix defines a network of generally repeating, interconnected, compartments or cells of the nanomatrix (coating layer 16) material that encompass and also interconnect the dispersed metallic powder particles 14. As used herein, “nanomatrix” is used to describe the size or scale of the matrix, particularly the thickness of the matrix between adjacent dispersed particles 14. The metallic coating layers that are sintered together to form the nanomatrix are themselves nanoscale thickness coating layers. Since the nanomatrix at most locations, other than the intersection of more than two dispersed metallic powder particles 14, generally comprises the interdiffusion and bonding of two coating layers 16 from adjacent powder particles 14 having nanoscale thicknesses, the matrix formed also has a nanoscale thickness (e.g., approximately two times the coating layer thickness as described herein) and is thus described as a nanomatrix. Further, the use of the term dispersed metallic powder particles 14 does not connote the minor constituent of powder compact 100, but rather refers to the majority constituent or constituents, whether by weight or by volume. The use of the term dispersed particle is intended to convey the discontinuous and discrete distribution of metallic material 12 within powder compact 100.

Powder compact 100 may have any desired shape or size, including that of a cylindrical billet, bar, sheet or other form that may be machined, formed or otherwise used to form useful articles of manufacture, including various wellbore tools and components. Forming 330 may be used to form powder compact 100 and deform the metallic powder particles 14 and coating layers 16 to provide the full theoretical density and desired macroscopic shape and size of powder compact 200 as well as its microstructure, or may be used to provide compacted articles having less than full theoretical density. The morphology (e.g. equiaxed or substantially elongated) of the dispersed metallic powder particles 14 and cellular network of coating layers 16 results from sintering and deformation of the powder particles as they are compacted and interdiffuse and deform to fill the interparticle spaces. In one embodiment, the sintering temperatures and forming 330 pressures may be selected to ensure that the density of powder compact 100 achieves substantially full theoretical density.

In addition, prior to forming 330, the metallic powder particles 14, either prior to depositing 320 of the coating layers 16 or afterwards, may receive mechanical or other treatment to provide nanostructuring within the metallic powder particles 14, or both the metallic powder particles 14 and the coating layers 16, to provide nanostructured metallic powder particles 14. By using nanostructured metallic powder particles 14 during forming 330, the resulting powdered compacts 100 may also comprise a nanostructured material. In an exemplary embodiment, a nanostructured material is a material having a grain size, or a subgrain or crystallite size, less than about 200 nm, and more particularly a grain size of about 10 nm to about 200 nm, and even more particularly an average grain size less than about 100 nm. The nanostructure may include high angle boundaries, which are usually used to define the grain size, or low angle boundaries that may occur as substructure within a particular grain, which are sometimes used to define a crystallite size, or a combination thereof. The nanostructure may be formed in the metallic powder particles 14 and/or coating layers 16 by any suitable method, including deformation-induced nanostructure such as may be provided by ball milling, and more particularly by cryomilling (e.g., ball milling in ball milling media at a cryogenic temperature or in a cryogenic fluid, such as liquid nitrogen). The metallic powder particles 14 may be formed as a nanostructured material by any suitable method, such as, for example, by milling or cryomilling of prealloyed powder particles of the magnesium or aluminum alloys described herein. The metallic powder particles 14 and/or coating layers 16 may also be formed as a nanostructured material 215 by methods including inert gas condensation, chemical vapor condensation, pulse electron deposition, plasma synthesis, crystallization of amorphous solids, electrodeposition and severe plastic deformation, for example. The nanostructure also may include a high dislocation density, such as, for example, a dislocation density between about 10¹⁷ m⁻² and 10¹⁸ m⁻², which may be two to three orders of magnitude higher than similar alloy materials deformed by traditional methods, such as cold rolling. The fine powders formed using the method 200, as well as the unique particle morphologies, including particle clusters and porous particles, may afford additional nanostructuring by virtue of their small size or unique features, since the clusters will tend to form boundaries associated with the metallic powder particles incorporated into the cluster and the porous particles will provide additional boundaries associated with the pores as they closed during forming. This additional nanostructuring is expected to further enhance the mechanical properties of powder compacts 100 formed from these metallic powders 10, such as the ultimate compressive strength, yield strength and the like.

While one or more embodiments have been shown and described, modifications and substitutions may be made thereto without departing from the spirit and scope of the invention. Accordingly, it is to be understood that the present invention has been described by way of illustrations and not limitation.

1. A method of making a nanoscale metallic powder, comprising:
providing a base material comprising a metallic compound, wherein the base material is configured for chemical reduction by a reductant to form a metallic material;
forming a powder of the base material, the powder comprising a plurality of powder particles, the powder particles having an average particle size that is less than about 1 micron; and
disposing the powder particles in a reactor together with the reductant under an environmental condition that promotes the chemical reduction of the base material and formation of a plurality of particles of the metallic material.

2. The method of claim 1, wherein the base material comprises a magnesium compound or an aluminum compound, or a combination thereof.

3. The method of claim 1, wherein the base material comprises a magnesium compound and the plurality of particles of the metallic material comprise magnesium or a magnesium alloy, or a combination thereof.

4. The method of claim 1, wherein the magnesium compound comprises magnesium chloride, magnesium fluoride, magnesium iodide, magnesium nitride, magnesium nitrate, magnesium bicarbonate, magnesium oxide, magnesium peroxide, magnesium selenide, magnesium telluride or magnesium sulfide, or a combination thereof.

5. The method of claim 1, wherein the base material comprises an aluminum compound and the plurality of particles of the metallic material comprise aluminum or an aluminum alloy, or a combination thereof.

6. The method of claim 1, wherein the aluminum compound comprises aluminum borate, aluminum bromide, aluminum chloride, aluminum hydroxide, aluminum nitride, aluminum oxide, aluminum phosphate, aluminum selenide, aluminum sulfate, aluminum sulfide, aluminum telluride or a combination thereof.

7. The method of claim 1, wherein the base material comprises a magnesium compound and an aluminum compound and the plurality of particles of the metallic material comprise magnesium or a magnesium alloy and aluminum or an aluminum alloy, or a combination thereof.

8. The method of claim 1, wherein the reductant comprises a group I element.

9. The method of claim 1, wherein the reductant comprises hydrogen or a hydrogen compound.

10. The method of claim 9, wherein the reductant comprises hydrogen gas.

11. The method of claim 1, wherein the plurality of particles of the metallic material have an average particle size that is less than the particle size of the powder particles.

12. The method of claim 1, wherein the plurality of particles of the metallic material have an average particle size of about 1 nm to about 1 micron.

13. The method of claim 12, wherein the plurality of particles of the metallic material have an average particle size of about 5 nm to about 500 nm.

14. The method of claim 12, wherein the plurality of particles of the metallic material have an average particle size of about 1 nm to about 15 nm.

15. The method of claim 1, wherein the plurality of particles of the metallic material have a particle morphology that is determined by a molecular structure of the base material.

16. The method of claim 1, wherein the plurality of particles of the metallic material have a porous particle morphology.

17. The method of claim 1, wherein disposing the powder particles in a reactor comprises disposing the powder particles into a fluidized bed reactor, wherein the powder particles comprise a fluidized bed of powder particles and the reductant comprises a fluid that is configured to flow through and form the fluidized bed of powder particles.

18. The method of claim 17, wherein the environmental condition comprises heating the fluidized bed to a predetermined temperature sufficient to chemically reduce the powder particles and form the particles of the metallic material.

19. The method of claim 18, wherein the reductant comprises hydrogen or a hydrogen compound.

20. The method of claim 1, wherein disposing the powder particles into a reactor comprises:
spraying the powder particles into the reactor to provide a stream of powder particles; and
providing a flow of the reductant through the reactor, the flow of the reductant through the reactor impinging upon the stream of powder particles.

21. The method of claim 20, wherein the environmental condition comprises heating the stream of powder particles and the reductant to a predetermined temperature sufficient to chemically reduce the powder particles and form the particles of the metallic material.

22. The method of claim 21, wherein the reductant comprises hydrogen or a hydrogen compound.

23. The method of claim 20, further comprising, prior to spraying, combining the powder particles with a liquid carrier to form a slurry, wherein spraying the powder particles comprises spraying the slurry.

24. The method of claim 23, wherein the liquid carrier comprises an organic or an inorganic liquid, or a combination thereof.

25. The method of claim 24, wherein the inorganic liquid comprises an aqueous liquid.

26. The method of claim 1, wherein disposing the powder particles into a reactor comprises:
disposing the powder particles into the reactor comprises placing the powder particles into a batch furnace, continuous furnace or kiln; and
providing a flow of the reductant through the reactor, the flow of the reductant through the reactor exposing the powder particles to the reductant.

27. The method of claim 26, wherein the environmental condition comprises heating the stream of powder particles and the reductant to a predetermined temperature sufficient to chemically reduce the powder particles and form the particles of the metallic material.

28. The method of claim 27, wherein the reductant comprises hydrogen or a hydrogen compound.

29. The method of claim 1, wherein the environmental condition comprises a predetermined temperature, predetermined pressure, predetermined electric field, predetermined electric current or predetermined voltage, or a combination thereof.

30. The method of claim 1, wherein forming a powder of the base material comprises ball milling or cryomilling the base material to form the powder particles.

31. The method of claim 1, further comprising ball milling or cryomilling the plurality of particles of the metallic material.

32. A metallic powder comprises a plurality of powder particles comprising magnesium or aluminum, or a combination thereof, wherein the powder particles have a predetermined particle morphology resulting from reduction from a magnesium compound or an aluminum compound, or a combination thereof, respectively.

33. The metallic powder of claim 32, wherein the predetermined particle morphology comprises porosity.

34. The metallic powder of claim 32, wherein the predetermined particle morphology comprises a particle size of about 1 to about 100 nm.

35. The metallic powder of claim 32, wherein the predetermined particle morphology comprises a particle cluster.

36. The metallic powder of claim 32, wherein the powder particles comprise nanostructured powder particles.

37. The metallic powder of claim 32, wherein the powder particles comprise a magnesium core and at least one metallic coating layer comprising Ni, Fe, Cu, Co, W, Al, Zn, Mn, Mg or Si, or an oxide, nitride, carbide, intermetallic compound or cermet comprising at least one of the foregoing, or a combination thereof.

38. The metallic powder of claim 32, wherein the powder particles comprise an aluminum core and at least one metallic coating layer comprising Ni, Fe, Cu, Co, W, Al, Zn, Mn, Mg or Si, or an oxide, nitride, carbide, intermetallic compound or cermet comprising at least one of the foregoing, or a combination thereof.

39. A method of making a powder metal compact, comprising:
providing a metallic powder that comprises a plurality of powder particles comprising magnesium or aluminum, or a combination thereof, by direct reduction of a base powder comprising a plurality of powder particles of a magnesium compound or an aluminum compound, or a combination thereof, respectively, the base powder particles having an average particle size that is less than about 1 micron;
depositing a nanoscale metallic coating layer of a metallic coating material on outer surfaces of the metallic powder particles to form coated metallic powder particles; and
forming a powder metal compact by sintering of the nanoscale metallic coating layers of the plurality of coated metallic powder particles to form a substantially-continuous, cellular nanomatrix of the metallic coating material and a plurality of dispersed particles comprising the metallic powder particles dispersed within the cellular nanomatrix.

40. The method of claim 39, wherein the plurality of particles of the metallic material have an average particle size of about 1 nm to about 1 micron.

41. The method of claim 40, wherein the plurality of particles of the metallic material have an average particle size of about 5 nm to about 500 nm.

42. The method of claim 39, wherein the plurality of metallic powder particles have a particle morphology that is determined by a molecular structure of the base powder.

43. The method of claim 39, wherein the plurality of metallic powder particles have a porous particle morphology.

44. The method of claim 39, further comprising ball milling or cryomilling the plurality of metallic powder particles, wherein the metallic powder particles comprise nanostructured powder particles.

45. The method of claim 39, wherein forming comprises cold pressing, hot pressing, forging or extrusion, or a combination thereof.
